(19) United States
(12) Patent Application Publication
(10) Pub. No.: US 2026/0310584 A1
(43) Pub. Date: Oct. 8, 2026

(54) Test Recommendation Based on a Source Code Dependency Graph and Code Coverage Results

(71) Applicant: Dell Products L.P., Round Rock, TX (US)

(72) Inventors: Andrea Roggerone, Dublin (IE); Brian Rochford, Ovens (IE); Steven Soumpholphakdy, Austin, TX (US)

(21) Appl. No.: 19/098,816

(22) Filed: Apr. 2, 2025

(51) Int. Cl. G06F 11/3668

(52) U.S. Cl. CPC G06F 11/3676; G06F 11/3688

(57) ABSTRACT

A system can create a dependency graph that represents dependencies within computer code. The system can add respective attributes to the respective nodes that identify respective check tests that are associated with the respective files. The system can, for a pull request regarding the computer code, determine a first subgroup of the files that is modified by the pull request, and a group of functions that is modified by the pull request. The system can, based on the dependency graph, the first subgroup of the files, and the group of functions, identify call chains of the computer code that are affected by the group of functions, and a second subgroup of the files that is affected by the group of functions, and determine a subgroup of the check tests that corresponds to a portion of the computer code that is modified by the pull request.

### BACKGROUND

Software code can be tested to identify errors in the code.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can create a dependency graph that represents dependencies within computer code, wherein nodes of the dependency graph represent files of the computer code, wherein edges of the dependency graph represent respective relationships between respective files of the files, and wherein respective nodes of the nodes are associated with respective control flow graphs for respective code blocks of the computer code that are stored in the respective files. The system can add respective attributes to the respective nodes that identify respective check tests that are associated with the respective files. The system can, for a pull request regarding the computer code, determine a first subgroup of the files that is modified by the pull request, and a group of functions that is modified by the pull request. The system can, based on the dependency graph, the first subgroup of the files, and the group of functions, identify call chains of the computer code that are affected by the group of functions, and a second subgroup of the files that is affected by the group of functions. The system can, based on the dependency graph, the call chains, and the second subgroup of the files, determine a subgroup of the check tests that corresponds to a portion of the computer code that is modified by the pull request. The system can store an indication of the subgroup of the check tests.

An example method can comprise creating, by a system comprising at least one processor, a dependency graph that represents dependencies within computer code, wherein nodes of the dependency graph represent files of the computer code, wherein edges of the dependency graph represent respective relationships between respective files of the files, wherein respective nodes of the nodes are associated with respective control flow graphs for respective code blocks of the computer code that are stored in the respective files, and wherein respective attributes of the respective nodes identify respective check tests that are associated with the respective files. The method can further comprise, for a pull request regarding the computer code, determining, by the system, a first subgroup of the files that is modified by the pull request, and a group of functions that is modified by the pull request. The method can further comprise, based on the dependency graph, the first subgroup of the files, and the group of functions, identifying, by the system, call chains of the computer code that are impacted by the group of functions, and a second subgroup of the files that is impacted by the group of functions. The method can further comprise, based on the dependency graph, the call chains, and the second subgroup of the files, determining, by the system, a subgroup of the check tests that corresponds to a portion of the computer code that is modified by the pull request.

An example non-transitory computer-readable medium can comprise instructions that, in response to execution, cause a system comprising a processor to perform operations. These operations can comprise creating a dependency graph that represents dependencies within computer code, wherein nodes of the dependency graph represent files of the computer code, wherein edges of the dependency graph represent respective relationships between respective files of the files, wherein respective nodes of the nodes are associated with respective control flow graphs for respective code blocks of the computer code that are stored in the respective files, and wherein respective attributes of the respective nodes identify respective check tests that are associated with the respective files. These operations can further comprise, for a pull request regarding the computer code, determining a first subgroup of the files that is modified by the pull request, and a group of functions that is modified by the pull request. These operations can further comprise, based on the dependency graph, the first subgroup of the files, the group of functions, call chains of the computer code that are affected by the group of functions, and a second subgroup of the files that are affected by the group of functions, determining a subgroup of the check tests that corresponds to a portion of the computer code that is modified by the pull request.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate test recommendation based on a source code dependency graph and code coverage results, in accordance with an embodiment of this disclosure;

FIG. 2 illustrates an example of a pull request impact report, and that can facilitate test recommendation based on a source code dependency graph and code coverage results, in accordance with an embodiment of this disclosure;

FIG. 3 illustrates an example of a baseline coverage report, and that can facilitate test recommendation based on a source code dependency graph and code coverage results, in accordance with an embodiment of this disclosure;

FIG. 4 illustrates an example of a pull request test recommendation report, and that can facilitate test recommendation based on a source code dependency graph and code coverage results, in accordance with an embodiment of this disclosure;

FIG. 5 illustrates an example process flow that can facilitate test recommendation based on a source code dependency graph and code coverage results, in accordance with an embodiment of this disclosure;

FIG. 6 illustrates an example process flow for test recommendation, and that can facilitate test recommendation based on a source code dependency graph and code coverage results, in accordance with an embodiment of this disclosure;

FIG. 7 illustrates another example process flow that can facilitate test recommendation based on a source code dependency graph and code coverage results, in accordance with an embodiment of this disclosure;

FIG. 8 illustrates another example process flow that can facilitate test recommendation based on a source code dependency graph and code coverage results, in accordance with an embodiment of this disclosure;

FIG. 9 illustrates another example process flow that can facilitate test recommendation based on a source code dependency graph and code coverage results, in accordance with an embodiment of this disclosure; and

FIG. 10 illustrates an example block diagram of a computer operable to execute an embodiment of this disclosure.

### DETAILED DESCRIPTION

### Overview

When developing code, developers can want to ensure that changes that are made do not cause any sort of regression. Prior approaches to addressing this generally involve writing new unit tests, confirming no regression in existing unit tests (e.g., failing tests that previously passed), and some level of manual testing. These prior approaches can be useful for the developer to sanity check, but are generally not exhaustive.

The present techniques can be implemented to provide a method where, based on a code diff, there can be a determination of a set of automated functional tests (that is, test lists) and unit tests that are to be executed to ensure that a regression has not been introduced.

A graph from each source code file and its dependencies can be generated based on a source scanning tool that creates a dependency graph of a source tree. Each of those files can be augmented with flow information from a control-flow-graph that captures defined functions and their subsequent call chains.

A dependency graph can generally comprise nodes that represent files, and directed edges between the nodes that represent dependencies between the files (e.g., Function A of File A calls Function B of File B). A control flow diagram (CFG) can generally represent the flow control within a program. A CFG can be structured a directed graph where code blocks are represented as nodes and flow paths are represented by edges. A CFG can be used in analysis and optimization of an execution flow within a software program.

This approach can generally involve three components:
A pull request (PR) impact generator;
A code coverage report analyzer; and
A test recommender.

The PR impact generator can take two inputs:
An enhanced dependency graph using a control flow graph (CFG), which can be referred to as a dependency graph (DG).
A pull request difference (diff) relative to an existing code base.

The PR impact generator can analyze the pull request diff and determine which files are touched and which functions within the files were modified.

Using the DG, the PR impact generator can then find call chains and respective files within the source tree that leverage the functions that were modified. From here, an analysis can be performed on each of the impacted call chains to determine which check tests are impacted. This can be done by adding an attribute to nodes in the DG that identify which files point to check tests. Once that is in place, the graph can be queried in a manner that facilitates looking for any node that contains the functions used in its CFG.

This information can be included in a report that can comprise:
Files that are touched by the diff;
Functions within that file that are modified; and
Relevant check tests that can be executed to validate no regression has been introduced.

This information can be included in a report (e.g., a document in a JavaScript Object Notation (JSON) structure) to be used as an input for the test recommender.

The other component according to the present techniques is the code coverage report analyzer. Unlike the PR impact generator that can be intended to be run every time a PR is generated, it can be that there no hard requirement as to how often the code coverage report analyzer should run. In some examples, it can be that it needs to be run often enough to ensure the code coverage report still provides valuable results against the PR impact report. That is, the code coverage report can serve as a baseline, and, if the code base deviates enough over time, a new baseline can be determined.

The code coverage report analyzer can take, as an input, the code coverage reports from test lists executed on different platforms, and outputs a baseline coverage report.

The baseline coverage report can provide the following details for each test list executed:
Name of the test list;
Platform the list was executed on; and
The coverage report for the execution of the test list on the given platform.

Using the coverage report, the analyzer can:
Compare coverage reports from different platforms running the same test list. If the reports match (that is, lines tested match), those platforms can be deemed as being equivalent. Any non-matching platforms can be assumed to be testing different code paths, and can be deemed not equivalent to others.
Analyze each of the coverage reports and determine which files are touched and what functions are impacted by the test list.

Using the baseline coverage report and the PR impact report, this information can be passed to a test recommender. The test recommender can look at the PR impact report and cycle through the files that are touched by the diff. Knowing this, the test recommender can cycle through the baseline coverage report and walk through each of the lists looking to find tests that touch those files. If the files are touched, the test recommender can then look at functions modified from the diff. If those same functions are touched in the baseline coverage report, then the tests can be appended to the test recommendation.

After cycling through the files within the PR impact report, and the tests from the baseline coverage report, a new test recommendation report can be generated that includes:
Check tests to be executed;
   This can come from the PR impact generator;
Which tests to execute and on what platforms;
   If a test list identified has equivalency defined, this information can be included in this report, and it can be left to the test executor to determine which platform it should run on. That test executor can know to only execute on one of the supported platforms, and can inspect the infra to see what is the “most” available.

The present techniques can facilitate using a CFG to determine check unit tests impacted by a code change. The present techniques can also facilitate determining a minimum test matrix (test and platform) by cross-referencing code coverage data and a code diff.

### Example Architecture, Etc.

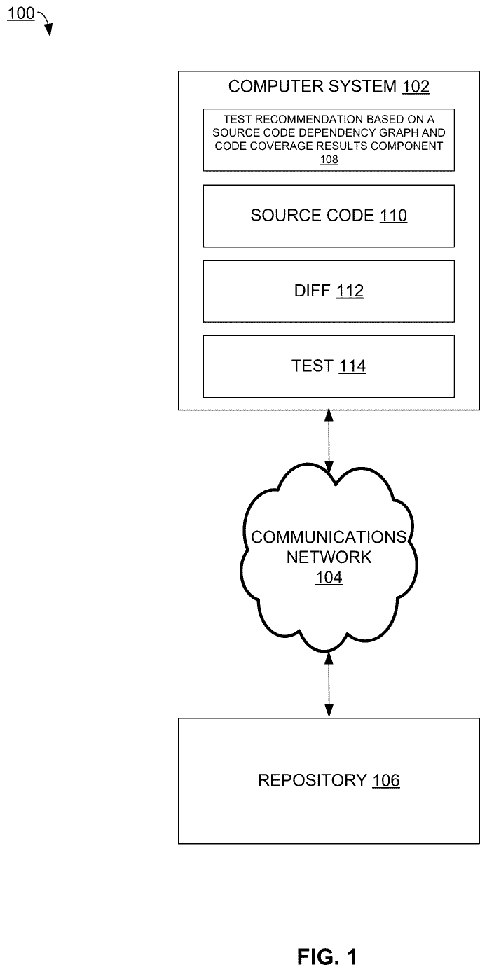

FIG. 1 illustrates an example system architecture 100 that can facilitate test recommendation based on a source code dependency graph and code coverage results, in accordance with an embodiment of this disclosure.

System architecture 100 comprises computer system 102, communications network 104, and repository 106. In turn, computer system 102 comprises test recommendation based on a source code dependency graph and code coverage results component 108, code base 110, diff 112, and tests 114.

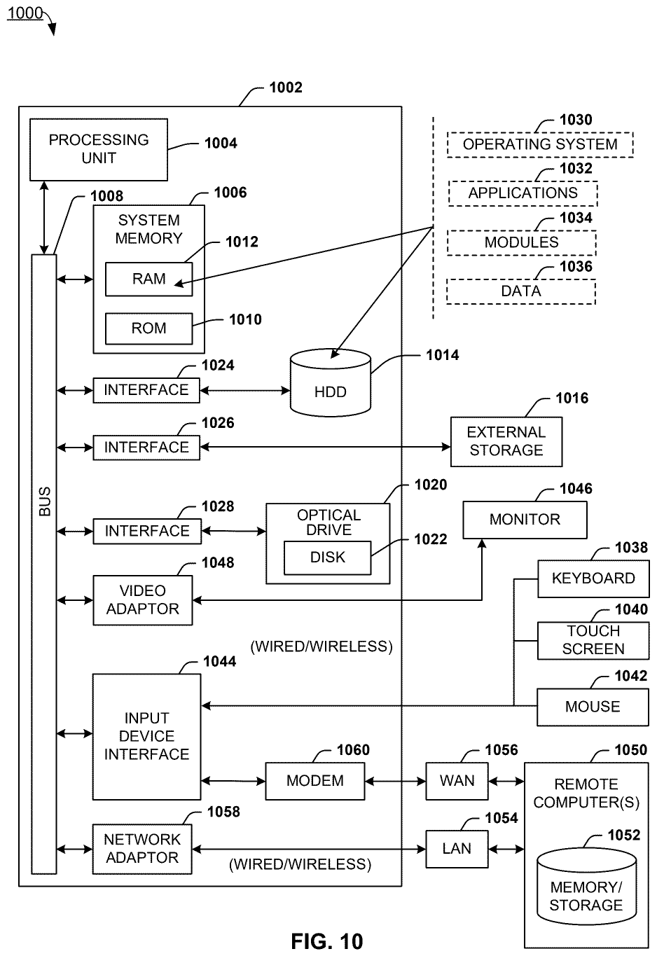

Each of computer system 102 and/or repository 106 can be implemented with part(s) of computing environment 1000 of FIG. 10. Communications network 104 can comprise a computer communications network, such as the Internet.

Repository 106 can store source code for computer applications. When a pull request is made to a code base in repository 106, that can be fetched by test recommendation based on a source code dependency graph and code coverage results component 108, as code base 110. A difference (diff) between code of the pull request and code base 110 can be determined as diff 112. Tests 114 can be check tests for code base 110 that can detect whether the code of code base 110 has errors.

Test recommendation based on a source code dependency graph and code coverage results component 108 can use this information to build a dependency graph of code base 110 to determine which files contain which functions and which interdependencies (e.g., a Function A in File A calls Function B in File B). This information can be used to determine which tests test the code that is modified in diff 112, and then to test diff 112 (without re-running every test of tests 114, which can consume computing resources on re-testing parts of the code that are unmodified in the pull request).

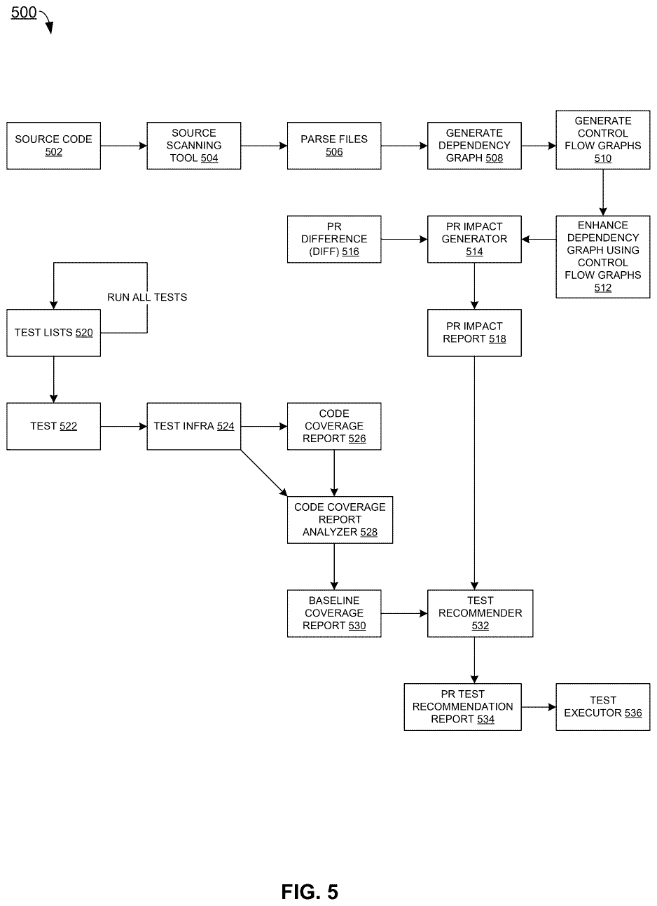

In some examples, test recommendation based on a source code dependency graph and code coverage results component 108 can implement part(s) of the process flows of FIGS. 5-9 to implement test recommendation based on a source code dependency graph and code coverage results.

It can be appreciated that system architecture 100 is one example system architecture for test recommendation based on a source code dependency graph and code coverage results, and that there can be other system architectures that facilitate test recommendation based on a source code dependency graph and code coverage results.

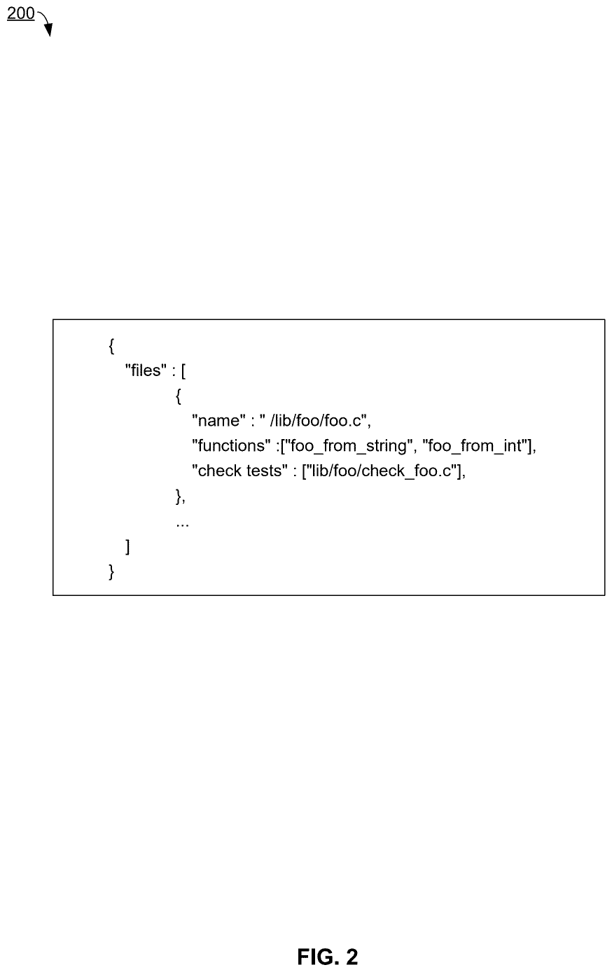

FIG. 2 illustrates an example 200 of a pull request impact report, and that can facilitate test recommendation based on a source code dependency graph and code coverage results, in accordance with an embodiment of this disclosure. In some examples, part(s) of example 200 can be used by part(s) of system architecture 100 of FIG. 1 to facilitate test recommendation based on a source code dependency graph and code coverage results.

Example 200 shows:

{
“files”:[
{
“name”: “/lib/foo/foo.c”,
“functions”:[“foo_from_string”, “foo_from_int”],
“check tests”: [“lib/foo/check_foo.c”],
},
. . .
]
}

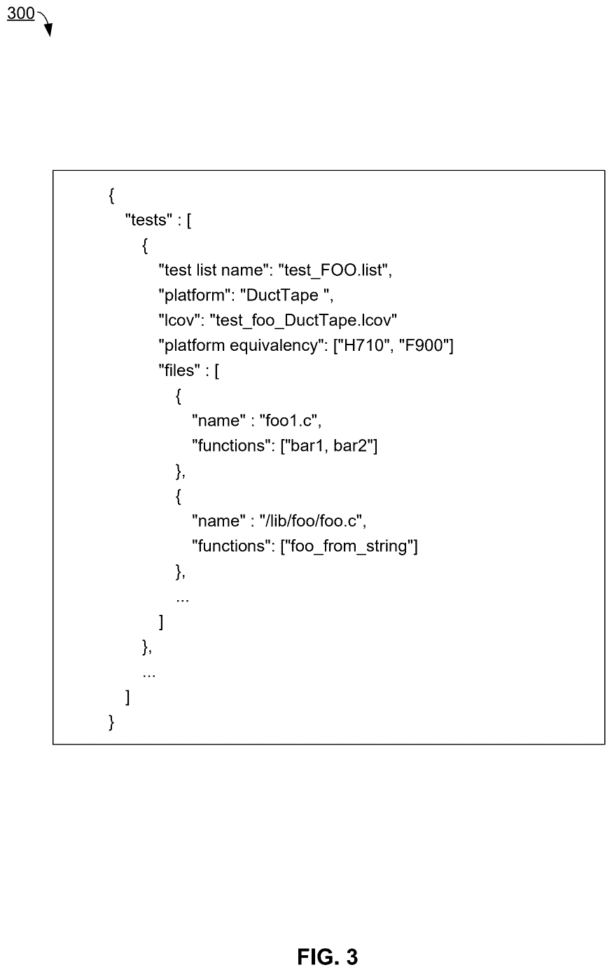

FIG. 3 illustrates an example 300 of a baseline coverage report, and that can facilitate test recommendation based on a source code dependency graph and code coverage results, in accordance with an embodiment of this disclosure. In some examples, part(s) of example 300 can be used by part(s) of system architecture 100 of FIG. 1 to facilitate test recommendation based on a source code dependency graph and code coverage results.

{
“tests”: [
{
“test list name”: “test_FOO.list”,
“platform”: “DuctTape”,
“lcov”: “test_FOO_DuctTape.lcov”
“platform equivalency”: [“H710”, “F900”]
“files”: [
{
“name”: “foo1.c”,
“functions”: [“bar1, bar2”]
},
{
“name”: “/lib/foo/foo.c”,
“functions”: [“foo_from_string”]
},
. . .
]
},
. . .
]
}

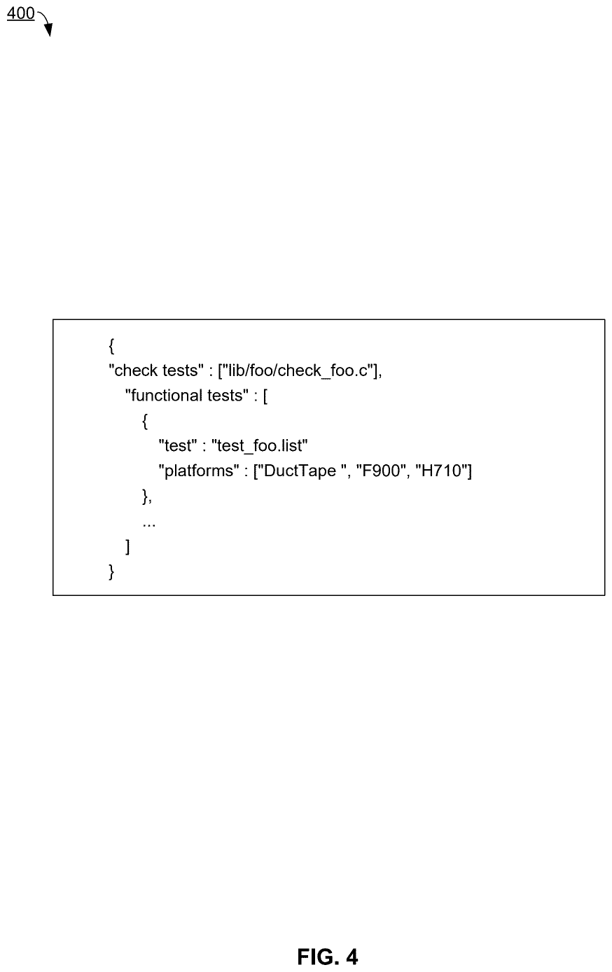

FIG. 4 illustrates an example 400 of a pull request test recommendation report, and that can facilitate test recommendation based on a source code dependency graph and code coverage results, in accordance with an embodiment of this disclosure. In some examples, part(s) of example 400 can be used by part(s) of system architecture 100 of FIG. 1 to facilitate test recommendation based on a source code dependency graph and code coverage results.

{
“check tests”: [“lib/foo/check_foo.c”],
“functional tests”: [
{
“test”: “test_FOO.list”
“platforms”: [“DuctTape”, “F900”, “H710”]
},
. . .
]
}

### Example Process Flows

FIG. 5 illustrates an example process flow 500 that can facilitate test recommendation based on a source code dependency graph and code coverage results, in accordance with an embodiment of this disclosure. In some examples, one or more embodiments of process flow 500 can be implemented by test recommendation based on a source code dependency graph and code coverage results component 108 of FIG. 1, or computing environment 1000 of FIG. 10.

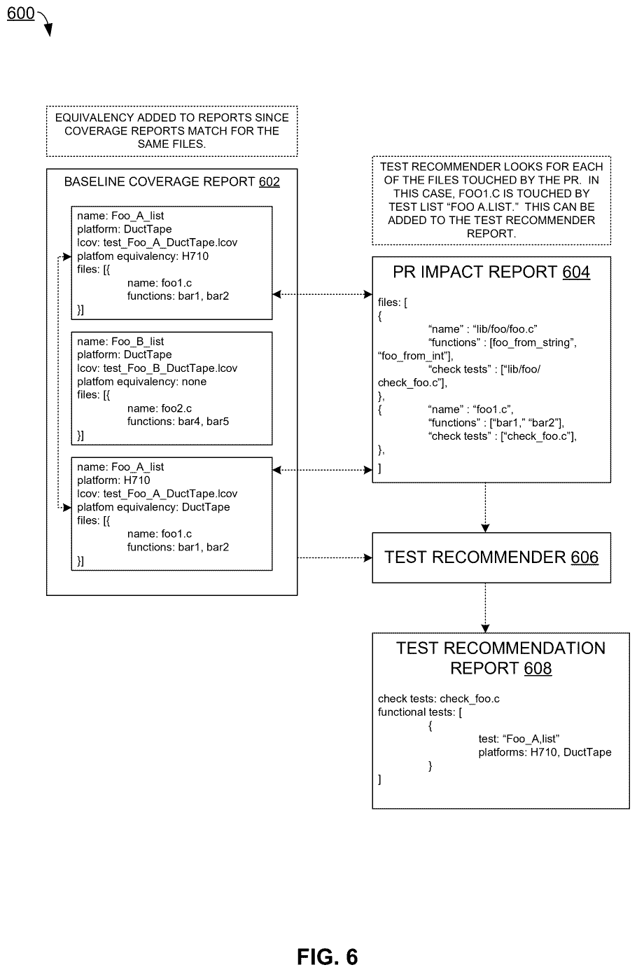

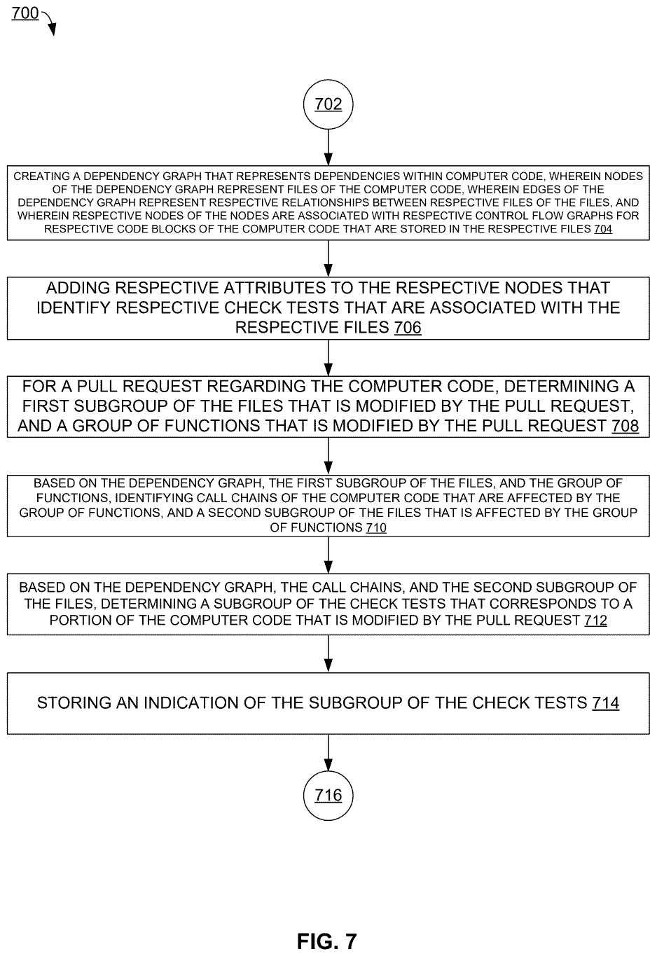

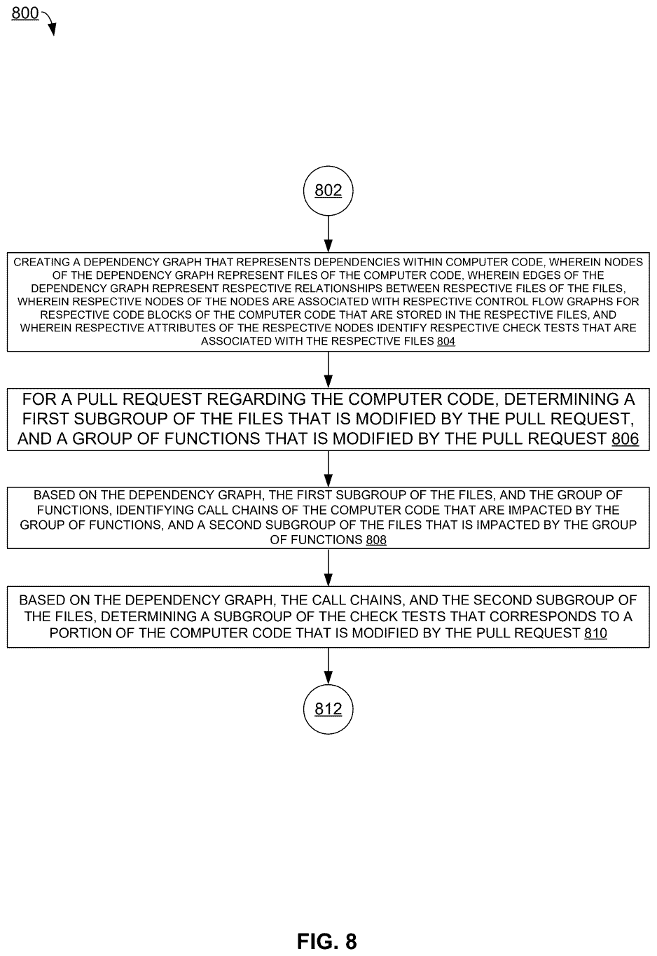

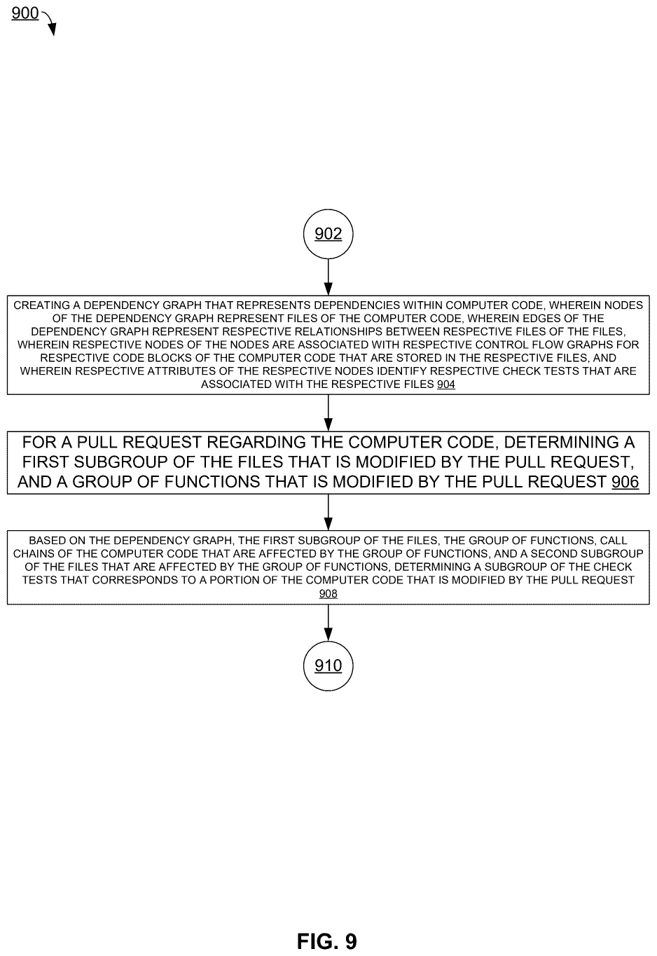

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 600 of FIG. 6, process flow 700 of FIG. 7, process flow 800 of FIG. 8, and/or process flow 900 of FIG. 9.

Process flow 500 comprises source code 502, source scanning tool 504, parse files 506, generate dependency graph 508, generate control flow graphs 510, enhance dependency graph using control flow graphs 512, PR impact generator 514, PR difference (diff) 516, PR impact report 518, test lists 520, test 522, test infrastructure (infra) 524, code coverage report 526, code coverage report analyzer 528, baseline coverage report 530, test recommender 532, PR test recommendation report 534, and test executor 536.

FIG. 6 illustrates an example process flow 600 for test recommendation, that can facilitate test recommendation based on a source code dependency graph and code coverage results, in accordance with an embodiment of this disclosure. In some examples, one or more embodiments of process flow 600 can be implemented by test recommendation based on a source code dependency graph and code coverage results component 108 of FIG. 1, or computing environment 1000 of FIG. 10.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow of FIG. 5, process flow 700 of FIG. 7, process flow 800 of FIG. 8, and/or process flow of FIG. 9.

Process flow 600 comprises baseline coverage report 602, PR impact report 604, test recommender 606, and test recommendation report 608.

Baseline coverage report 602 identifies:

name: Foo_A_list
platform: DuctTape
lcov: test_Foo_A_DuctTape.lcov
platform equivalency: H710
files: [{
name: foo1.c
functions: bar1, bar2
}]
name: Foo_B_list
platform: DuctTape
lcov: test_Foo_B_DuctTape.lcov
platform equivalency: none
files: [{
name: foo2.c
functions: bar4, bar5
}]
name: Foo_A_list
platform: DuctTape
lcov: test_Foo_A_DuctTape.lcov
platform equivalency: DuctTape
files: [{
name: foo1.c
functions: bar1, bar2
}]

In baseline coverage report 602, two of the coverage reports match for the same files, so an indication of this equivalency is added to the reports.

PR impact report 604 indicates: files:

files: [
{
“name”: “lib/foo/foo.c”
“functions”: [foo_from_string”, “foo_from_int”],
“check tests”: [“lib/foo/check_foo.c”],
},
{
“name”: “foo1.c”,
“functions”: [“bar1,” “bar2”],
“check tests”: [“check_foo.c”],
},
]

In PR impact report 604, a test recommender looks for each of the files touched by the PR. In this case, foo1.c is touched by test list “Foo_A. list.” This can be added to the test recommender report.

Test recommendation report 608 indicates:

check tests: check_foo.c
functional tests: [
{
test: “Foo_A,list”
platforms: H710, DuctTape
}
]

FIG. 7 illustrates another example process flow 700 that can facilitate test recommendation based on a source code dependency graph and code coverage results, in accordance with an embodiment of this disclosure. In some examples, one or more embodiments of process flow 700 can be implemented by test recommendation based on a source code dependency graph and code coverage results component 108 of FIG. 1, or computing environment 1000 of FIG. 10.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 500 of FIG. 5, process flow 600 of FIG. 6, process flow 800 of FIG. 8, and/or process flow 900 of FIG. 9.

Process flow 700 begins with 702, and moves to operation 704.

Operation 704 depicts creating a dependency graph that represents dependencies within computer code, wherein nodes of the dependency graph represent files of the computer code, wherein edges of the dependency graph represent respective relationships between respective files of the files, and wherein respective nodes of the nodes are associated with respective control flow graphs for respective code blocks of the computer code that are stored in the respective files. This can be a dependency graph and control flow graphs as described herein.

After operation 704, process flow 700 moves to operation 706.

Operation 706 depicts adding respective attributes to the respective nodes that identify respective check tests that are associated with the respective files. That is, the check tests associated with the files can be added to the dependency graph at the nodes that correspond to the files.

In some examples, a file that contains check tests can be identified by a prefix in its file name.

After operation 706, process flow 700 moves to operation 708.

Operation 708 depicts, for a pull request regarding the computer code, determining a first subgroup of the files that is modified by the pull request, and a group of functions that is modified by the pull request. This can be implemented in a similar manner as a PR impact generator as described herein, and can involve analyzing a pull request diff (the diff between the updated file(s) of the pull request and the prior version of those file(s) stored in a repository) to determine which files are modified and which functions within those files are modified.

After operation 708, process flow 700 moves to operation 710.

Operation 710 depicts, based on the dependency graph, the first subgroup of the files, and the group of functions, identifying call chains of the computer code that are affected by the group of functions, and a second subgroup of the files that is affected by the group of functions. This can comprise determining the call chains (e.g., a sequence of function calls in computer code that lead up to a particular execution point in executing that code) and other files (e.g., those that contain functions used in a call chain) using the dependency graph.

After operation 710, process flow 700 moves to operation 712.

Operation 712 depicts, based on the dependency graph, the call chains, and the second subgroup of the files, determining a subgroup of the check tests that corresponds to a portion of the computer code that is modified by the pull request. That is, the information of operations 708-710 can be used to find check tests that are relevant to the pull request.

After operation 712, process flow 700 moves to operation 714.

Operation 714 depicts, storing an indication of the subgroup of the check tests.

In some examples, the indication is a first indication, implementing the pull request on the computer code produces modified computer code, and operation 714 comprises performing the subgroup of the check tests on the modified computer code to produce a validation result that indicates whether a regression has been introduced by the pull request, and storing a second indication of the validation result. That is, the check tests identified in operation 714 can be executed against the computer code to identify possible errors with the computer code.

In some examples, the indication is a first indication, and operation 714 comprises storing a second indication of the first subgroup of the files that is modified by the pull request. In some examples, operation 714 comprises storing a second indication of the group of functions that is modified by the pull request. That is, a report can comprise files that are touched by a diff, functions within those files that are modified, and relevant check tests that can be executed to validate that no regression has been introduced by the updated computer code.

In some examples, the indication of the subgroup of the check tests is stored in a structured key-value format that is human-readable. That is, a report can be in a format such as a JSON format, and can be used as an input for a test recommender.

In some examples, operation 714 comprises performing respective iterations of the determining the first subgroup of the files and the group of functions, the identifying of the call chains and the second subgroup of the files, the determining of the subgroup of the check tests, and the storing of the indication of the subgroup of the check tests for respective pull requests that comprise the pull request. That is, a PR impact generator can be run each time a PR is generated.

After operation 714, process flow 700 moves to 716, where process flow 700 ends.

FIG. 8 illustrates another example process flow 800 that can facilitate test recommendation based on a source code dependency graph and code coverage results, in accordance with an embodiment of this disclosure. In some examples, one or more embodiments of process flow 800 can be implemented by test recommendation based on a source code dependency graph and code coverage results component 108 of FIG. 1, or computing environment 1000 of FIG. 10.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 500 of FIG. 5, process flow 600 of FIG. 6, process flow 700 of FIG. 7, and/or process flow 900 of FIG. 9.

Process flow 800 begins with 802, and moves to operation 804.

Operation 804 depicts creating a dependency graph that represents dependencies within computer code, wherein nodes of the dependency graph represent files of the computer code, wherein edges of the dependency graph represent respective relationships between respective files of the files, wherein respective nodes of the nodes are associated with respective control flow graphs for respective code blocks of the computer code that are stored in the respective files, and wherein respective attributes of the respective nodes identify respective check tests that are associated with the respective files. In some examples, operation 804 can be implemented in a similar manner as operations 704-706 of FIG. 7.

After operation 804, process flow 800 moves to operation 806.

Operation 806 depicts, for a pull request regarding the computer code, determining a first subgroup of the files that is modified by the pull request, and a group of functions that is modified by the pull request. In some examples, operation 806 can be implemented in a similar manner as operation 710 of FIG. 7.

After operation 806, process flow 800 moves to operation 808.

Operation 808 depicts, based on the dependency graph, the first subgroup of the files, and the group of functions, identifying call chains of the computer code that are impacted by the group of functions, and a second subgroup of the files that is impacted by the group of functions. In some examples, operation 808 can be implemented in a similar manner as operation 710 of FIG. 7.

After operation 808, process flow 800 moves to operation 810.

Operation 810 depicts, based on the dependency graph, the call chains, and the second subgroup of the files, determining a subgroup of the check tests that corresponds to a portion of the computer code that is modified by the pull request. In some examples, operation 810 can be implemented in a similar manner as operation 712 of FIG. 7.

In some examples, the subgroup of the check tests is a first subgroup of the check tests, and operation 810 comprises determining a baseline coverage report for the computer code, based on execution of a second subgroup of the check tests for the computer code on a platform, an identification of the platform, and a coverage report for the execution of the second subgroup of the check tests for the computer code on the platform.

In some examples, operation 810 comprises determining the baseline coverage report based on respective executions of respective second subgroups of the check tests for the computer code on respective platforms, wherein the respective second subgroups of the check tests comprise the second subgroup of the check tests, and wherein the platforms comprise the platform.

That is, a code coverage report analyzer can take, as input, code coverage reports from test lists executed on different platforms, and output a baseline coverage report. A baseline coverage report can include the following example details for each test list executed: name of test list, platform the list was executed on, and the coverage report for the execution of the test list on the given platform.

In some examples, operation 810 comprises determining that a first platform of the platforms and a second platform of the platforms are equivalent based on a first coverage report corresponding to the first platform being determined to match a second coverage report corresponding to the second platform.

In some examples, operation 810 comprises determining that a first platform of the platforms and a second platform of the platforms are inequivalent based on a first coverage report corresponding to the first platform differing from a second coverage report corresponding to the second platform.

In some examples, operation 810 comprises, based on the coverage report and the dependency graph, determining a third subgroup of the files that correspond to the coverage report.

In some examples, the group of functions is a first group of functions, and operation 810 comprises, based on the coverage report and the dependency graph, determining a second group of functions that corresponds to the coverage report.

That is, using a coverage report, an analyzer can compare coverage reports from different platforms running the same test list. If the reports match (that is, lines tested match), those platforms can be deemed as being equivalent. Any non-matching platforms can be assumed to be testing different code paths, and can be deemed not equivalent to others. The analyzer can also analyze each of the coverage reports and determine which files are touched and what functions are impacted by the test list.

In some examples, the determining of the baseline coverage report is performed independently of receiving the pull request. That is, unlike the PR impact generator that can be intended to be run every time a PR is generated, it can be that there is no hard requirement as to how often the code coverage report analyzer should run. In some examples, it can be that it needs to be run often enough to ensure the code coverage report still provides valuable results against the PR impact report. That is, the code coverage report can serve as a baseline, and, if the code base deviates enough over time, a new baseline can be determined.

After operation 810, process flow 800 moves to 812, where process flow 800 ends.

FIG. 9 illustrates another example process flow 900 that can facilitate test recommendation based on a source code dependency graph and code coverage results, in accordance with an embodiment of this disclosure. In some examples, one or more embodiments of process flow 900 can be implemented by test recommendation based on a source code dependency graph and code coverage results component 108 of FIG. 1, or computing environment 1000 of FIG. 10.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 500 of FIG. 5, process flow 600 of FIG. 6, process flow 700 of FIG. 7, and/or process flow 800 of FIG. 8.

Process flow 900 begins with 902, and moves to operation 904.

Operation 904 depicts creating a dependency graph that represents dependencies within computer code, wherein nodes of the dependency graph represent files of the computer code, wherein edges of the dependency graph represent respective relationships between respective files of the files, wherein respective nodes of the nodes are associated with respective control flow graphs for respective code blocks of the computer code that are stored in the respective files, and wherein respective attributes of the respective nodes identify respective check tests that are associated with the respective files. In some examples, operation 904 can be implemented in a similar manner as operations 704-706 of FIG. 7.

After operation 904, process flow 900 moves to operation 906.

Operation 906 depicts, for a pull request regarding the computer code, determining a first subgroup of the files that is modified by the pull request, and a group of functions that is modified by the pull request. In some examples, operation 906 can be implemented in a similar manner as operation 710 of FIG. 7.

After operation 906, process flow 900 moves to operation 908.

Operation 908 depicts based on the dependency graph, the first subgroup of the files, the group of functions, call chains of the computer code that are affected by the group of functions, and a second subgroup of the files that are affected by the group of functions, determining a subgroup of the check tests that corresponds to a portion of the computer code that is modified by the pull request. In some examples, operation 908 can be implemented in a similar manner as operations 710-712 of FIG. 7.

In some examples, operation 908 comprises determining a baseline coverage report for the computer code, based on respective executions of respective second subgroups of tests for the computer code on respective platforms, respective identifications of the respective platforms, and respective coverage reports for the respective execution of the respective second subgroups of tests for the computer code on the respective platforms.

In some examples, the group of functions is a first group of functions, and operation 908 comprises, based on the baseline coverage report and the first subgroup of the files that are modified by the pull request, identifying a second group of functions covered by the baseline coverage report and that is affected by the pull request.

In some examples, the subgroup of the check tests is a first subgroup of the check tests, and operation 908 comprises, generating a test recommendation report that identifies a second subgroup of the check tests based on the second group of functions covered by the baseline coverage report and that is affected by the pull request.

In some examples, the test recommendation report identifies at least one platform on which to execute the second subgroup of the check tests.

In some examples, a first platform of the at least one platform and a second platform of the at least one platform that are identified in the test recommendation report correspond to a test of the second subgroup of the check tests, and operation 908 comprises selecting one of the first platform or the second platform according to an availability criterion, to produce a selected platform, and executing the test on the selected platform, while refraining running the test from the other of the first platform and the second platform.

That is, using the baseline coverage report and the PR impact report, this information can be passed to a test recommender. The test recommender can look at the PR impact report and cycle through the files that are touched by the diff. Knowing this, the test recommender can cycle through the baseline coverage report and walk through each of the lists looking to find tests that touch those files. If the files are touched, the test recommender can then look at functions modified from the diff. If those same functions are touched in the baseline coverage report, then the tests can be appended to the test recommendation.

After cycling through the files within the PR impact report, and the tests from the baseline coverage report, a new test recommendation report can be generated that includes check tests to be executed (this can come from the PR impact generator). The recommendation report can also include an indication of which tests to execute and on what platforms. If a test list identified has equivalency defined, this information can be included in this report, and it can be left to the test executor to determine which platform it should run on. That test executor can know to only execute on one of the supported platforms, and can inspect the infra to see what is the “most” available.

After operation 908, process flow 900 moves to 910, where process flow 900 ends.

### Example Operating Environment

In order to provide additional context for various embodiments described herein, FIG. 10 and the following discussion are intended to provide a brief, general description of a suitable computing environment 1000 in which the various embodiments of the embodiment described herein can be implemented.

For example, parts of computing environment 1000 can be used to implement one or more embodiments of computer system 102 and/or repository 106.

In some examples, computing environment 1000 can implement one or more embodiments of the process flows of FIGS. 5-9 to facilitate test recommendation based on a source code dependency graph and code coverage results.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a nonvolatile storage such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can also be connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples, and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
creating a dependency graph that represents dependencies within computer code, wherein nodes of the dependency graph represent files of the computer code, wherein edges of the dependency graph represent respective relationships between respective files of the files, and wherein respective nodes of the nodes are associated with respective control flow graphs for respective code blocks of the computer code that are stored in the respective files;
adding respective attributes to the respective nodes that identify respective check tests that are associated with the respective files;
for a pull request regarding the computer code, determining a first subgroup of the files that is modified by the pull request, and a group of functions that is modified by the pull request;
based on the dependency graph, the first subgroup of the files, and the group of functions, identifying call chains of the computer code that are affected by the group of functions, and a second subgroup of the files that is affected by the group of functions;
based on the dependency graph, the call chains, and the second subgroup of the files, determining a subgroup of the check tests that corresponds to a portion of the computer code that is modified by the pull request; and
storing an indication of the subgroup of the check tests.

2. The system of claim 1, wherein the indication is a first indication, wherein implementing the pull request on the computer code produces modified computer code, and wherein the operations further comprise:
performing the subgroup of the check tests on the modified computer code to produce a validation result that indicates whether a regression has been introduced by the pull request; and
storing a second indication of the validation result.

3. The system of claim 1, wherein the indication is a first indication, and wherein the operations further comprise:
storing a second indication of the first subgroup of the files that is modified by the pull request.

4. The system of claim 1, wherein the indication is a first indication, and wherein the operations further comprise:
storing a second indication of the group of functions that is modified by the pull request.

5. The system of claim 1, wherein the indication of the subgroup of the check tests is stored in a structured key-value format that is human-readable.

6. The system of claim 1, wherein the operations further comprise:
performing respective iterations of the determining the first subgroup of the files and the group of functions, the identifying of the call chains and the second subgroup of the files, the determining of the subgroup of the check tests, and the storing of the indication of the subgroup of the check tests for respective pull requests that comprise the pull request.

7. A method, comprising:
creating, by a system comprising at least one processor, a dependency graph that represents dependencies within computer code, wherein nodes of the dependency graph represent files of the computer code, wherein edges of the dependency graph represent respective relationships between respective files of the files, wherein respective nodes of the nodes are associated with respective control flow graphs for respective code blocks of the computer code that are stored in the respective files, and wherein respective attributes of the respective nodes identify respective check tests that are associated with the respective files;
for a pull request regarding the computer code, determining, by the system, a first subgroup of the files that is modified by the pull request, and a group of functions that is modified by the pull request;
based on the dependency graph, the first subgroup of the files, and the group of functions, identifying, by the system, call chains of the computer code that are impacted by the group of functions, and a second subgroup of the files that is impacted by the group of functions; and
based on the dependency graph, the call chains, and the second subgroup of the files, determining, by the system, a subgroup of the check tests that corresponds to a portion of the computer code that is modified by the pull request.

8. The method of claim 7, wherein the subgroup of the check tests is a first subgroup of the check tests, and further comprising:
determining, by the system, a baseline coverage report for the computer code, based on execution of a second subgroup of the check tests for the computer code on a platform, an identification of the platform, and a coverage report for the execution of the second subgroup of the check tests for the computer code on the platform.

9. The method of claim 8, further comprising:
determining, by the system, the baseline coverage report based on respective executions of respective second subgroups of the check tests for the computer code on respective platforms, wherein the respective second subgroups of the check tests comprise the second subgroup of the check tests, and wherein the platforms comprise the platform.

10. The method of claim 7, further comprising:
determining, by the system, that a first platform of the platforms and a second platform of the platforms are equivalent based on a first coverage report corresponding to the first platform being determined to match a second coverage report corresponding to the second platform.

11. The method of claim 7, further comprising:
determining, by the system, that a first platform of the platforms and a second platform of the platforms are inequivalent based on a first coverage report corresponding to the first platform differing from a second coverage report corresponding to the second platform.

12. The method of claim 8, further comprising:
based on the coverage report and the dependency graph, determining, by the system, a third subgroup of the files that correspond to the coverage report.

13. The method of claim 8, wherein the group of functions is a first group of functions, and further comprising:
based on the coverage report and the dependency graph, determining, by the system, a second group of functions that corresponds to the coverage report.

14. The method of claim 8, wherein the determining of the baseline coverage report is performed independently of receiving the pull request.

15. A non-transitory computer-readable medium comprising instructions that, in response to execution, cause a system comprising at least one processor to perform operations, comprising:
creating a dependency graph that represents dependencies within computer code, wherein nodes of the dependency graph represent files of the computer code, wherein edges of the dependency graph represent respective relationships between respective files of the files, wherein respective nodes of the nodes are associated with respective control flow graphs for respective code blocks of the computer code that are stored in the respective files, and wherein respective attributes of the respective nodes identify respective check tests that are associated with the respective files;
for a pull request regarding the computer code, determining a first subgroup of the files that is modified by the pull request, and a group of functions that is modified by the pull request; and
based on the dependency graph, the first subgroup of the files, the group of functions, call chains of the computer code that are affected by the group of functions, and a second subgroup of the files that are affected by the group of functions, determining a subgroup of the check tests that corresponds to a portion of the computer code that is modified by the pull request.

16. The non-transitory computer-readable medium of claim 15, wherein the operations further comprise:
determining a baseline coverage report for the computer code, based on respective executions of respective second subgroups of tests for the computer code on respective platforms, respective identifications of the respective platforms, and respective coverage reports for the respective execution of the respective second subgroups of tests for the computer code on the respective platforms.

17. The non-transitory computer-readable medium of claim 16, wherein the group of functions is a first group of functions, and wherein the operations further comprise:
based on the baseline coverage report and the first subgroup of the files that are modified by the pull request, identifying a second group of functions covered by the baseline coverage report and that is affected by the pull request.

18. The non-transitory computer-readable medium of claim 17, wherein the subgroup of the check tests is a first subgroup of the check tests, and wherein the operations further comprise:
generating a test recommendation report that identifies a second subgroup of the check tests based on the second group of functions covered by the baseline coverage report and that is affected by the pull request.

19. The non-transitory computer-readable medium of claim 18, wherein the test recommendation report identifies at least one platform on which to execute the second subgroup of the check tests.

20. The non-transitory computer-readable medium of claim 19, wherein a first platform of the at least one platform and a second platform of the at least one platform that are identified in the test recommendation report correspond to a test of the second subgroup of the check tests, and wherein the operations further comprise:
selecting one of the first platform or the second platform according to an availability criterion, to produce a selected platform; and
executing the test on the selected platform, while refraining running the test from the other of the first platform and the second platform.
